(19) United States
(12) Patent Application Publication
(10) Pub. No.: US 2009/0316788 A1
(43) Pub. Date: Dec. 24, 2009

(54) Video coding method with non-compressed mode and device implementing the method

(75) Inventors: Lionel Techernatinsky, Rennes (FR); Karine Lorvellec, LA MEZIERE (FR); Denis Mailleux, VITRUE (FR)

Correspondence Address: ROBERT D. SHEDD;THOMSON LICENSING LLC, PATENT OPERATIONS, P.O. BOX 5312, PRINCETON, NJ, 08543-5312, US

(73) Assignee: Thomson Licensing

(21) Appl. No.: 12/455,552

(22) Filed: Jun. 3, 2009

(30) Foreign Application Priority Data
Jun. 23, 2008 (EP) 0854134

(51) Int. Cl. H04N 7/32; H04N 7/26

(52) U.S. Cl. 375/240.16; 375/240.24; 375/E07.026

(57) ABSTRACT

The present invention relates to a video coding method comprising a mechanism enabling the activation or deactivation of the compression of video stream macroblocks to be coded according to the efficiency of compression and operating in at least two modes, the first coding mode being normal and the second mode being non-compressed, wherein said method comprises: in normal coding mode, the macroblock being processed is compressed by a coding loop then by an entropic coder, said compression being considered efficient if the size occupied by the macroblock after compression is notably less than the size that the macroblock occupies without compression, in the case where the compression of the macroblock being processed is not efficient, the non-compressed mode is activated, said non-compressed mode being characterized by the fact that the samples corresponding to the macroblock being processed reconstructed by the local decoder of the coding loop are transmitted without compression at the output of the coder.

Another purpose of the invention is a video coding device implementing the method.

### FIELD OF THE INVENTION

The invention relates to a method and a video coding device and applies particularly to the domains of video transmission, analysis, decoding and transcoding.

### DESCRIPTION OF THE PRIOR ART

A video sequence comprises by its nature a high statistical redundancy both in the temporal and spatial domains. The desire to always use more efficiently the transmission media bandwidths on which these sequences transit and the objective of reducing the cost of their storage posed the question very early on of video compression. The standard video compression techniques can generally be divided into two steps. The first aims to reduce the spatial redundancy and to do this to compress a fixed image. The image is first divided into blocks of pixels (of 4×4 or 8×8 according to, for example, the MPEG-1/2/4 standards), a passage into the frequency domain followed by a quantization enabling the approximation or deletion of high frequencies to which the eye is less sensitive, and finally the quantized data are coded in an entropic manner. The purpose of the second step is to reduce the temporal redundancy. This technique enables an image to be predicted from one or more other reference images previously decoded within the same sequence (motion estimation). This technique consists in searching in these reference images for the block that best corresponds to that to be predicted, and only a motion estimation vector is retained corresponding to the displacement of the block between the two images as well as a residual error enabling the visual yield to be refined.

A standard video encoder processing a video signal after slicing of the images into macroblocks is comprised specifically of the following two functional elements:
a coding loop realizing the passage into the frequency domain, the quantization, the motion compensation the intra prediction and the loop filtering,
an entropic coder realizing a compression without loss of signal after signal quantization, for example, with a Huffman coding or an arithmetic coding.

A macroblock is compressed by first being processed by the coding loop followed by the entropic coder. In standard systems, these two steps can be considered as being independent.

The compression techniques using motion estimation and intra prediction prove to be very efficient and practical. However, for some images of a video stream and/or when the quantization uses a very weak step, the compression provides inconclusive results. Notably it is possible to have at the output of a video coder a number of bits after compression greater than the number of bits of the source. In this case it is more advantageous to transmit the stream in non-compressed mode, that is to say transmit at the output of the video encoder the samples of the source video corresponding to the macroblock currently being processed. As an example, the H.264 standard defines a non-compressed mode called I_PCM mode. When this mode is activated, the source samples, that is the luminance and chrominance components representing the image pixels are transmitted directly to the functional block carrying out the entropic coding and are formatted there. In this case, no compression is applied. There are two use cases of the I_PCM coding mode in the H.264 standard:
use in standard coding mode: The I_PCM mode can be used by an encoder in the same way as all the other proposed modes, it is noted that the bitrate generated per macroblock is then constant,
use in fallback mode: a maximum size is imposed on the stream of bits generated for the coding of a macroblock. This signifies that if the number of bits corresponding to a macroblock following compression exceeds a limit value, the I_PCM mode is used and the samples of the source video are transmitted directly.

The limit value imposed by the standard for use in fallback mode is fixed at the value at which an encoder ceases to reduce the bitrate and where it becomes more interesting to transmit the source directly. For example, during 4:2:0 coding on 8 bits, a macroblock is represented on 3072 bits. The H.264 standard defines the maximum number of bits, or 3200 bits, beyond which use of the I_PCM coding mode is required. The number of bits required for coding a non-compressed macroblock corresponds to the bits required at the transmission of luminance and chrominance samples, or the 3072 bits previously cited as well as the bits required at the transmission of mode information (mb_type and mb_skip_flag, for example). The decision to use this coding mode as well as the implementation of the I_PCM mode, when the fallback mode is considered, is made at entropic coder level. This checks number of bits generated following the processing of each macroblock by the coding loop and entropic coding. If this number is greater than a limit of 3200 bits, the bits generated are withdrawn from the final bits stream, the coding contexts are restored, that is to say the entropic coder returns to the preceding state in which it was at the start of the macroblock, and the source samples are transmitted in the bits stream. When the I_PCM mode is selected by the entropic coder, a control signal called ‘I_PCM_control’ is activated and is propagated for example to functional blocks of the coding loop carrying out the predictions (intra and inter), to the block carrying out the reconstruction and possibly to other blocks of the encoder according to the implementation choice.

The coding of a macroblock depends upon the coding of its neighbours. For example, in the case of the H.264 standard, there is a spatial dependence of the current macroblock with respect to the macroblock situated on its left and to the macroblock situated above it. Ideally, the coding of these macroblocks should be finished before being able to process the current macroblock.

In order to optimize the implementation of the encoder and avoid a purely sequential processing of macroblock after macroblock, it is usual to process the macroblocks in parallel. Due to the functional separation of the encoding loop and the entropic coder, the current macroblock can be processed before the processing of adjacent blocks is finished. For example, if the block on the left is currently undergoing entropic coding the processing operations of the encoding loop (transformation, quantization, etc.) can be applied in parallel to the current block. A “pipeline” type encoder architecture can thus be realized.

If the non-compressed mode is implemented in fallback mode, as the choice of activation or not of the mode is made at entropic coder level, it is not possible to foresee the manner in which the adjacent blocks will be coded before their processing by the entropic coder has finished It is necessary in this case to wait for the result of entropic coding and the processing operations of the encoding loop and the entropic coder can no longer be in parallel. When the coding mode of a macroblock is only know late as is the case when a non-compressed mode is selected by the entropic coder, numerous functional blocks cannot begin the next macroblock processing operations before the arrival of this information. In fact, during a late change in the coding mode, the contextual information of a current macroblock become incoherent. When there is a “pipeline” in the realization of the encoder, it is observed that the information of preceding macroblocks is also incoherent. The “pipeline” of the coding loop begins at prediction operator level, then passes by the operators of transformation, quantization, inverse quantization and inverse transformation, reconstruction and intra prediction to return to the prediction operator level. Another “pipeline” begins at the quantization operator output and carries out all the entropic coding operations that comprise, among others, the operations of binarization, arithmetic coding and the choice of macroblock coding in compressed or non-compressed mode. The coding loop and the entropic coder can carry out their operations in parallel, the two pipelines do not therefore have the same depth and are not synchronized, the processing of the current macroblock by the coding loop cannot begin before the end of processing of the preceding macroblock, while the entropic coder can begin the processing of the current macroblock before finishing the processing of the preceding macroblock. When the entropic coder chooses the non-compressed mode, the account taken of this new coding mode by the “pipeline” of the coding loop provokes the appearance of incoherent data at the output of the coding loop. This incoherence results from for example the account taken, during the coding of the current macroblock following a non-compressed macroblock, of a macroblock reconstructed according to the coding loop that is different from the non-compressed macroblock present in the bitstream. The consequence is that distortions are introduced in the video sequence when the non-compressed mode is used.

In practice this dependence renders difficult the realization of an encoder on a parallel platform (multiprocessor, DSP, FPGA or ASIC) in the presence of non-compressed macroblocks. As an example, if it is required to process 1620 macroblocks per 40 millisecond period and a given implementation enables this temporal constraint to be satisfied by executing in parallel the operations of the encoding loop and the entropic coder, when the non-compressed mode is activated, the processing in parallel is rendered impossible and it becomes difficult to adhere to the 40 millisecond constraint.

In practice, in the case of H.264 encoders, the majority of implementations bypass the problem by not implementing the I_PCM coding mode. This is a statistically valid solution as the condition for the appearance of the I_PCM coding are rare. The inconvenience is that it remains possible to generate an incorrect stream from the syntactic or semantic perspective. Said stream cannot in consequence be decoded.

Another solution to the problem is to memorize at the level of the functional blocks of the video encoder the state of the macroblocks already coded and make a total restoration into a preceding state when an I_PCM macroblock appears. This solution presents two major disadvantages:
each of the functional blocks must be able to store the volume of data necessary to the restoration (samples, coding mode and other attributes such as motion vectors),
the bitstream is interrupted during restoration. This solution requires that the functional blocks must return to the coding of macroblocks that were already coded and therefore places macroblocks in standby.

### SUMMARY OF THE INVENTION

One purpose of the invention is notably to overcome the disadvantages described above.

To this end the purpose of the invention is a video coding method comprising a mechanism enabling the activation or deactivation of the compression of video stream macroblocks to be coded according to the efficiency of compression and operating in at least two modes, the first coding mode being normal and the second being non-compressed, said method being characterized in that:
in normal coding mode, the macroblock being processed is compressed by a coding loop then by an entropic coder, said compression being considered efficient if the size occupied by the macroblock after compression is noticeably less than the size occupied by the macroblock without compression,
in the case where the compression of the macroblock being processed is not efficient, the non-compressed mode is activated, said non-compressed mode being characterized by the fact that the samples corresponding to the macroblock being processed, reconstructed via the local decoder of the coding loop, are transmitted without compression at the output of the coder.

A variant of this method is characterized in that the compression efficiency is verified by comparing the number of bits after compression of the current macroblock with a threshold value.

A variant of the method is characterized in that the video coder follows the specifications of the H.264 standard.

A variant of this method is characterized in that when the non-compressed mode is activated, the spatial prediction of an intra macroblock from a neighbouring inter macroblock is authorized.

Another purpose of the invention is a video coding device implementing the method and characterized in that it comprises at least:
a coding loop enabling the compression of macroblocks applying at least the standard transform methods, of quantization, reconstruction, intra prediction and motion compensation on the incoming signal,
an entropic coder realizing in normal coding mode a compression of the data stream at the output of the coding loop and comprising the means to verify the efficiency of the compression and the means to the decide for the use of the non-compressed mode.

### BRIEF DESCRIPTION OF THE DRAWINGS

Other characteristics and advantages of the invention will emerge with the help of the description that follows provided as a non-restrictive example, made with regard to the annexed drawings wherein:

FIG. 1 illustrates an embodiment of the method according to the invention.

FIG. 2 presents an example of the video compression device comprising the method according to the invention.

The invention has notably the advantage of enabling the execution in parallel of the operations of the coding loop and of the entropic coder when the non-compressed mode is supported and so of reducing the operations execution time.

### DETAILED DESCRIPTION OF THE PREFERRED EMBODIMENTS

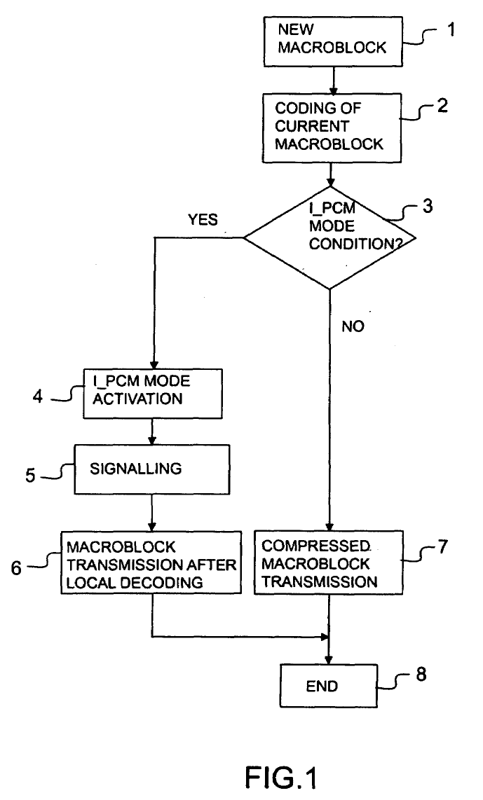

FIG. 1 shows with a diagram an example of implementation of the method according to the invention. The method is composed of steps to be applied for each macroblock of the video stream to be compressed. The method enables, initially, to detect if the compression is efficient for the macroblock being processed. Secondly, if the compression is not considered as efficient, the macroblock samples being processed from the output of the local decoder are transmitted in non-compressed state. The local decoding is typically carried out by the coding loop of the video coder in order to maintain at the level of the encoder the internal state of the video decoder. In the contrary case, if the compression is considered efficient, the compressed macroblock is transmitted at the output of the video coder.

As shown previously, a video coder is typically constituted of a coding loop and an entropic coder. In the example of FIG. 1, the notations introduced take into account the terminology specific to the H.264 standard. Hence the non-compressed mode is designated as being the I_PCM mode. The method according to the invention can be considered outside of the scope of the H.264 standard. The method according to the invention is executed at the level of the entropic coder for each macroblock processed by the video coder.

The method is executed as soon as a new macroblock is detected 1 at the input of the coder. The method according to the invention processes a compressed video stream macroblock by macroblock. A macroblock represents a part of an image of a video stream. This part of the image comprises a set of pixel blocks. As an example, a macroblock can represent 16×16 pixels of an image. The macroblock processed at a given instant by the method is called the current macroblock or the macroblock being processed, the two expressions having the same meaning.

The macroblock being processed is compressed 2 by the coding loop then by the entropic coder. The efficiency of the compression is then verified 3.

As previously cited as an example, if the coder works to the 4:2:0 format on 8 bits and the macroblock after having been compressed occupies more than 3200 bits, the use of the I_PCM mode is activated 4. The functional blocks of the coding loop of the video coder must then be configured as a consequence. To do this, a signalling is implemented 5. The bits generated after compression are then withdrawn from the bitstream at the output of the video coder. The functional block of the coding loop carrying out the intra prediction is configured in such a way that it can use for its predictions the intra macroblocks and the inter macroblocks. For a video coder complying to the H.264 standard, the marker constrained_intra_pred_flag is deactivated for this. Indeed, if this marker is activated, the spatial prediction of an intra macroblock from a neighbouring inter macroblock is prohibited and in this case the neighbouring inter macroblock is considered as unavailable. This then takes a value by default, for example 128. If thereafter this inter macroblock switches into I_PCM mode, the prediction with respect to the value 128 will not be correct. The I_PCM mode is considered as an intra mode by the H.264 standard. The late choice of the I_PCM mode returns to switch the coding mode of the current macroblock from an intra mode or an inter mode into an intra mode.

The macroblock being processed is then transmitted non-compressed after being processed by the local decoder of the coding loop. The execution of the method terminates 8.

If the compression of the macroblock being processed is efficient 3, the macroblock is transmitted compressed 7 at the output of the coder and the execution of the method terminates 8.

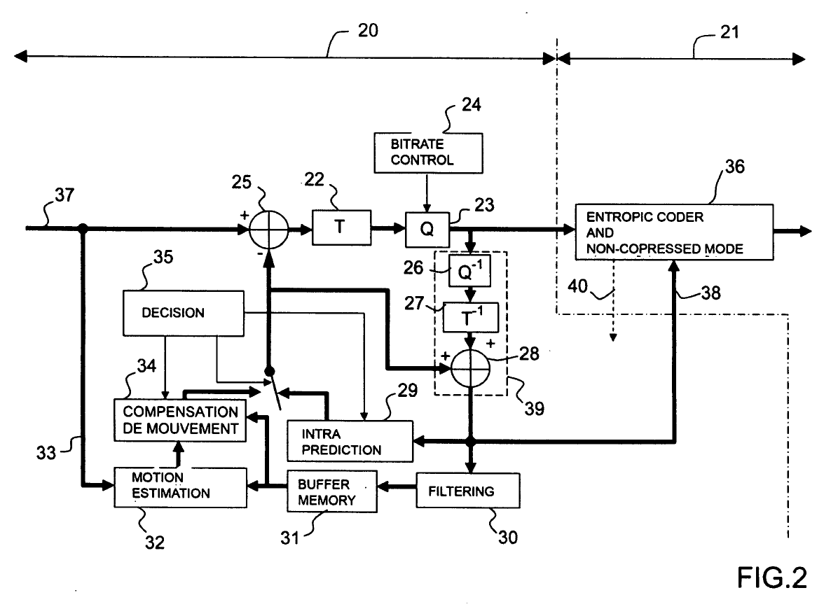

FIG. 2 shows an example of the video coding device implementing the method according to the invention. This is constituted of two main functional elements. The first is the coding loop 20 and the second is the entropic coder 21.

The principle of the coding loop 20 is of the prior art in video compression. A block 22 takes at input samples of the source after compensation 25, said block realizing a transform enabling passage from the temporal to the frequency domain. This transform can be for example an entire transform as specified in the H.264 standard. The result of the transform is then quantified 23, this operation destroys the data faintly visible to the human eye and reduces the amount of data to be transmitted. This operation is configured 24 according to, for example, the target bitrate to be guaranteed at the output of the video coder. The signal after quantization 23 is reconstructed using a local decoder 39 realizing the inverse quantization operations 26, the inverse transform operations 27 and the reconstruction operations 28. When the non-compressed mode is not used, the macroblock after reconstruction is used by a set of functional blocks realizing the intra prediction 29 and the loop filter 30. The reconstructed blocks are memorized by the frame buffer 31 in order to carry out the motion estimation 32 between the signal at the video coder input 33 and said memorized blocks 31. The result of the motion estimation 32, typically a motion estimation vector 34, is itself used for the motion compensation 34 for the purpose of creating a prediction. A decision functional block 35 enables the intra prediction 29 and/or the motion compensation 34 to be configured and activated.

The second part of the video coder 21 is composed notably of a functional block carrying out the entropic coding 36. In addition, this functional block 36 comprises the decision means enabling triggering of the non-compressed mode in the manner described in the example of FIG. 1. When the coding block 36 decides to the non-compressed mode, the samples of the current macroblock after decompression by the local decoder 39 are directed at the input to the entropic coder 36 to then be transmitted non-compressed at the output of the video coder. The coding loop is configured for this purpose using a signal 40 permitting the configuration of one or more elements of the coding loop according to the implementation chosen.

This example of a device implementing the method according to the invention enables the processing in parallel of operations of the coding loop and the entropic coder when the non-compressed mode is supported by the video coder while guarantying that the bitstream at the output of the video coder remains in compliance with the standard in terms of syntax and semantics.

1- Video coding method comprising a mechanism enabling the activation or deactivation of the compression of video stream macroblocks to be coded according to the efficiency of compression and operating in at least two modes, the first coding mode being normal and the second mode being non-compressed, wherein:
in normal coding mode, the macroblock being processed is compressed by a coding loop then by an entropic coder, said compression being considered efficient if the size occupied by the macroblock after compression is noticeably less than the size occupied by the macroblock without compression,
in the case where the compression of the macroblock being processed is not efficient, the non-compressed mode is activated, said non-compressed mode being characterized by the fact that the samples corresponding to the macroblock being processed, reconstructed via the local decoder of the coding loop, are transmitted without compression at the output of the coder.

2- Method according to claim 1 wherein the compression efficiency is verified by comparing the number of bits after compression of the current macroblock with a threshold value.

3- Method according to claim 1 wherein the video coding follows the specifications of the H.264 standard.

4- Method according to claim 1 wherein, when the non-compressed mode is activated, the spatial prediction of an intra macroblock from a neighbouring inter macroblock is authorized.

5- Video coding device implementing the method according to claim 1, comprising at least:
a coding loop enabling the compression of macroblocks applying at least the standard transform methods, of quantization, reconstruction, intra prediction and motion compensation on the incoming signal,
an entropic coder realizing in normal coding mode a compression of the data stream at the output of the coding loop and comprising the means to verify the efficiency of the compression and the means to the decide for the use of the non-compressed mode.
